(19) United States
(12) Patent Application Publication
(10) Pub. No.: US 2008/0062323 A1
(43) Pub. Date: Mar. 13, 2008

(54) High Intensity Display Screen Based Electronic Window

(75) Inventors: Eelco G. Visser, Best (NL); Mark T. Johnson, Veldhoven (NL); Saskia Blom, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/718,414

(22) PCT Filed: Nov. 2, 2005
(86) PCT No.: PCT/IB05/53579

§ 371 Date: May 2, 2007

Related U.S. Application Data
(60) Provisional application No. 60/624,796, filed on Nov. 3, 2004.

(51) Int. Cl. H04N 9/74

(52) U.S. Cl. 348/596; 348/E09.055

(57) ABSTRACT

An electronic window (21) employing an image taking device (22) mounted outside of a room for providing an image of a scenery external to the room. The electronic window (21) further employing a display screen (21) mounted within the room for displaying and illuminating the image at a luminance level for creating a sensation of a glass window being formed in the wall of the room. Alternatively or concurrently, the display screen (21) can direct an emission of a light beam within the room.

The present invention generally relates to electronic windows. The present invention specifically relates to an electronic window for creating a sensation of a glass window formed in a wall of closed room (e.g., a hospital room, a hotel room, an indoor shop, a work cubical, etc.).

In a room with no glass windows or glass windows having poor external illumination, the level of illumination within the room can be enhanced by artificial light from lamps located in the room. While this creates enough light for people to function in the room, the psychological stress due to lack of sufficient near-by windows cannot be compensated for by the artificial light.

The lighting industry is therefore continually striving to increase the illumination within dim rooms (e.g., a hospital room, a hotel room, an indoor shop, a work cubical, etc.) to improve upon the human experience with such dim environmental settings (e.g., U.S. Pat. No. 5,253,000). To this end, the present invention provides new and unique structural configurations of a display screen based electronic window for creating a sensation of a glass window formed in a wall of a room.

One form of the present invention is an electronic window employ an image taking device and a display screen. The image taking device is mounted outside of a room for providing an image of a scenery external to the room. The display screen is mounted within the room for displaying and illuminating the image at a luminance level for creating a sensation of a glass window formed in a wall of the room. Alternatively or concurrently, the display screen can direct an emission of a light beam within the room.

The foregoing form as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

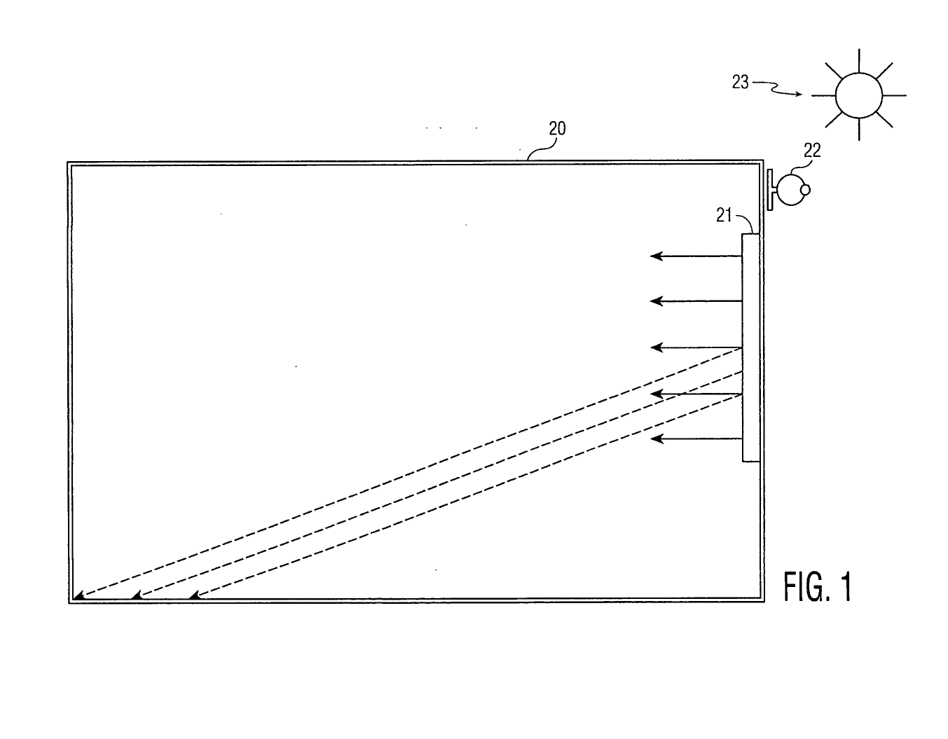

FIG. 1 illustrates an exemplary closed room being illuminated by a display screen based electronic window in accordance with the present invention; and

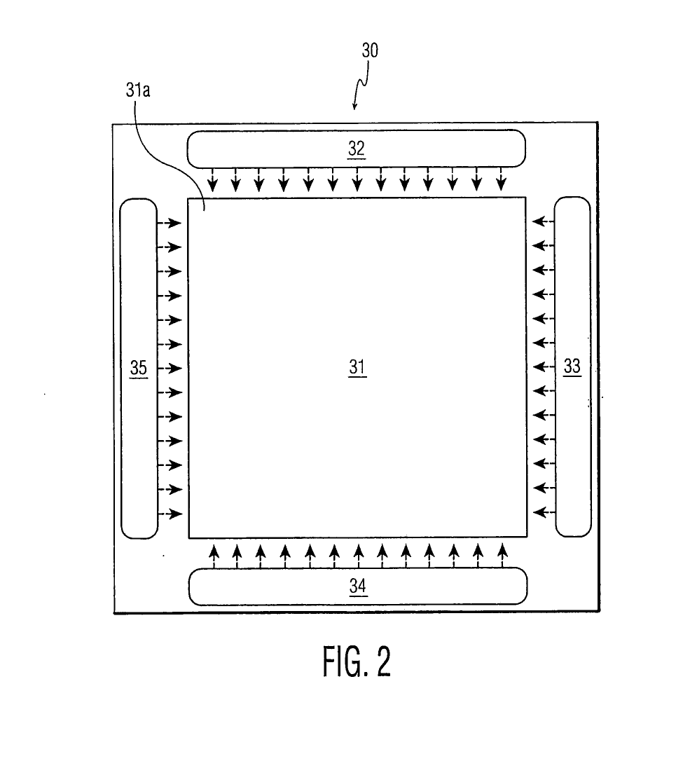

FIGS. 2-13 illustrate exemplary embodiments of the electronic window illustrated in FIG. 1.

A closed room 20 as illustrated in FIG. 1 is provided with an electronic window 21 serving as a glass window for illuminating room 20. One inventive principle of the present invention is to structurally configure electronic window 21 as a display screen with an appearance of a glass window (e.g., a rectangular plane having a minimum surface area of 0.5 m²) and a luminance level associated with a glass window (e.g., 1000 Cd/m² to 3000 Cd/m²) as compared to normal luminance levels of typical display screens (e.g., 100 Cd/m²). In one embodiment, electronic window 21 is structurally configured as a sufficiently bright, self-radiating display screen (e.g., a LED display, a LCD display, a plasma display or a diffusely reflectively display) that uniformly illuminates an image in all directions of room 20 as exemplary shown by the solid arrows illustrated in FIG. 1. Concurrently or alternatively, electronic window 21 is structurally configured as a display screen that shines a light beam under a skewed downward angle towards the floor inside room 20 as exemplary shown by the dashed arrows illustrated in FIG. 1. In any embodiment, a power consumption by electronic window 21 preferably should be between 200 W-400 W per 1000 Cd/m² for a rectangular plane of 1 m².

A second inventive principle of the present invention is to display a view of the outdoor scenery in the surrounding environment on electronic window 21. In one embodiment, an imaging taking device in the form of a web camera 22 as shown mounted on an outside wall of room 20 is in electrical communication with electronic window 21 (e.g., wireline or wireless) to provide images of the outdoor scenery in the surrounding environment, such as, for example, an image of the sun 23 shining in the direction of room 20.

In practice, the actual structural configurations of an electronic window is dependent upon commercial implementations of the present invention, and are therefore without limit. The following descriptions of FIGS. 2-13 provide exemplary embodiments of electronic windows incorporating one or more of the aforementioned inventive principles of the present invention.

FIG. 2 illustrates an electronic window 30 in the form of a display screen employing a rectangular light guide 31 overlaying an E-Ink layer (not shown) and up to four (4) light sources 32-35 facing respective light incident surfaces of light guide 31. In operation, light emitted by light sources 32-35 entering the light incident surfaces of light guide 31 will be emitted by light guide 31 via a front light exit surface 31 a where a portion of the light will initially be emitted by a rear light exit surface (not shown) of light guide 31 and reflected back by the E-ink layer into light guide 31 via the rear light exit surface. To provide sufficient brightness in view of a typical reflectivity of 40% by the E-ink layer, each lamp is preferably a 1 m long 50 W TL with an efficiency of 40 lm/W.

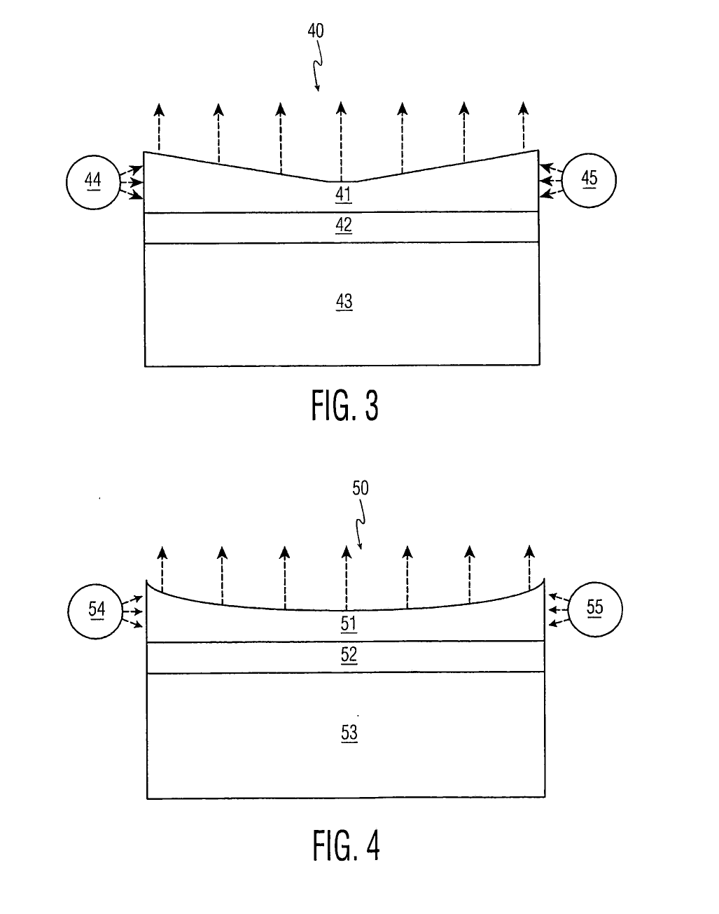

The following description herein of FIGS. 3-7 is directed to versions of electronic window 30 having two (2) white light sources for the ease in illustrating the various versions. Those having skill in the art will appreciate that, for versions of electronic window 30 having three (3) light sources or four (4) light sources, the illustrated light guides preferably have a three (3) fold symmetric shape or a four (4) fold symmetric shape, respectively, as compared to the illustrated two (2) fold symmetric shape.

FIG. 3 illustrates an electronic window 40 in the form of a display screen employing a rectangular light guide 41 overlaying an E-Ink layer 43 with a transparent layer 42 therebetween. Two (2) white light sources 44 and 45 face respective light incident surfaces of light guide 41. The dashed arrows highlight the emission of light from light sources 44 and 45 as well as light guide 41. To promote a uniform illumination, a refractive index of transparent layer 42 should be between a refractive index of light guide 41 and a refractive index of air.

FIG. 4 illustrates an electronic window 50 in the form of a display screen employing a rectangular light guide 51 overlaying an E-Ink layer 53 with a transparent layer 52 therebetween. Two (2) white light sources 54 and 55 face respective light incident surfaces of light guide 51. The dashed arrows highlight the emission of light from light sources 54 and 55 as well as light guide 51. To promote a uniform illumination, a refractive index of transparent layer 52 should be between a refractive index of light guide 51 and a refractive index of air.

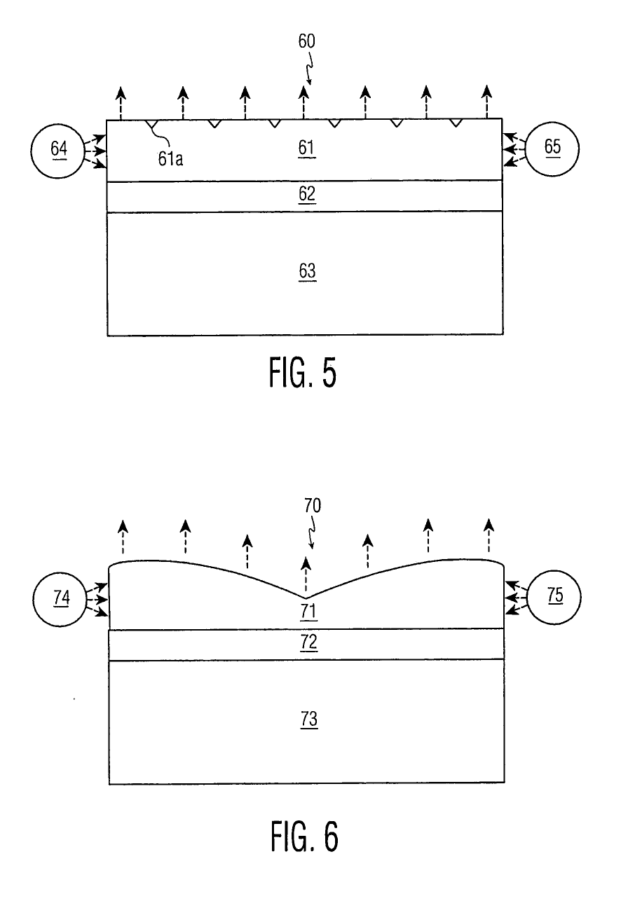

FIG. 5 illustrates an electronic window 60 in the form of a display screen employing a rectangular light guide 61 overlaying an E-Ink layer 63 with a transparent layer 62 therebetween. Light guide 61 includes six (6) diffractors 61a. Two (2) white light sources 64 and 65 face respective light incident surfaces of light guide 61. The dashed arrows highlight the emission of light from light sources 64 and 65 as well as light guide 61. To promote a uniform illumination, a refractive index of transparent layer 62 should be between a refractive index of light guide 61 and a refractive index of air.

FIG. 6 illustrates an electronic window 70 in the form of a display screen employing a rectangular light guide 71 overlaying an E-Ink layer 73 with a transparent layer 72 therebetween. Two (2) white light sources 74 and 75 face respective light incident surfaces of light guide 71. The dashed arrows highlight the emission of light from light sources 74 and 75 as well as a light guide 71. To promote a uniform illumination, a refractive index of transparent layer 72 should be between a refractive index of light guide 71 and a refractive index of air.

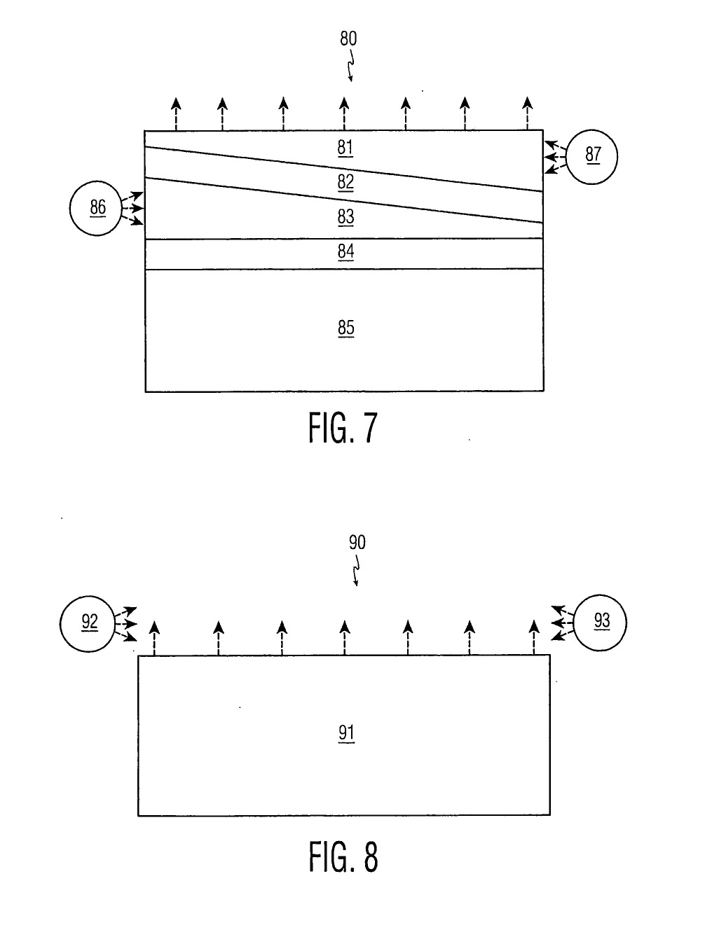

FIG. 7 illustrates an electronic window 80 in the form of a display screen employing a pair of wedge-shaped rectangular light guides 81 and 83 overlaying an E-Ink layer 85 with a transparent layer 82 between light guides 81 and 83, and a transparent layer 84 between light guides 83 and E-Ink layer 85. A light source 86 faces a light incident surface of light guide 83, and a light source 87 faces a light incident surface of light guide 81. The dashed arrows highlight the emission of light from light sources 86 and 87 as well as light guide 81. To promote a uniform illumination, a refractive index of light guides 81 and 83 should be greater than a refractive index of transparent layer 84, which should be greater than a refractive index of transparent layer 82.

FIG. 8 illustrates an electronic window 90 in the form of a display screen employing an E-ink layer 91 and a pair of light sources 92 and 93. The dashed arrows highlight the emission of light from light sources 92 and 93 as well as the reflection of light from E-ink layer 91.

Referring to FIGS. 3-8, a primary functionality of the various illustrated electronic windows is to provide a luminance level similar to that of a glass window. Thus, it is preferred that the various illustrated E-ink layers be composed of extra white particles to thereby provide an extra high white level over those provide by typical display screens employing an E-ink layer. Additionally, a certain amount of light leakage from the various illustrated light guides is acceptable in view of achieving a higher brightness level over typical display screens employing an E-ink layer. Furthermore, while the various illustrated electronic windows are front lighting devices, those having ordinary skill in the art will appreciate variations within the spirit of the present invention of these illustrated electronic windows

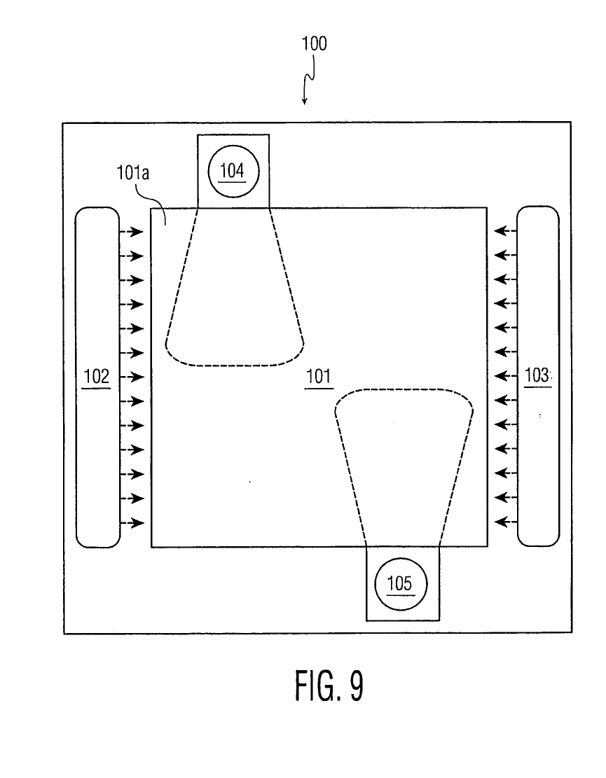

The following description of FIGS. 9-13 is premised on providing electronic windows in the form of display screens having a lower resolution than typical display screens, but is augmented by additional light sources (e.g., LEDs, spot lamps and collimated TL tubes via an internal diffuse reflector) that are not preferred in typical display screens.

FIG. 9 illustrates an electronic window 100 in the form of a display screen employing a light guide 101 overlaying an E-Ink layer (not shown) and two (2) white light sources 102 and 103 facing respective light incident surfaces of light guide 101. Electronic window 100 further employs one or more colored light sources to light incident surfaces of light guide 100, such as, for example, a colored light source 104 (e.g. blue LEDs, a blue spot lamp and a blue TL tube) and a colored light source 105 (e.g. red LEDs, a red spot lamp and a red TL tube) facing respective light incident surfaces of light guide 101 to augment the lighting of electronic window 100. The positioning of colored light sources 104 and 105 relative to the respective light incident surfaces of light guide 101 can be determined to maximize the brightness of electronic window.

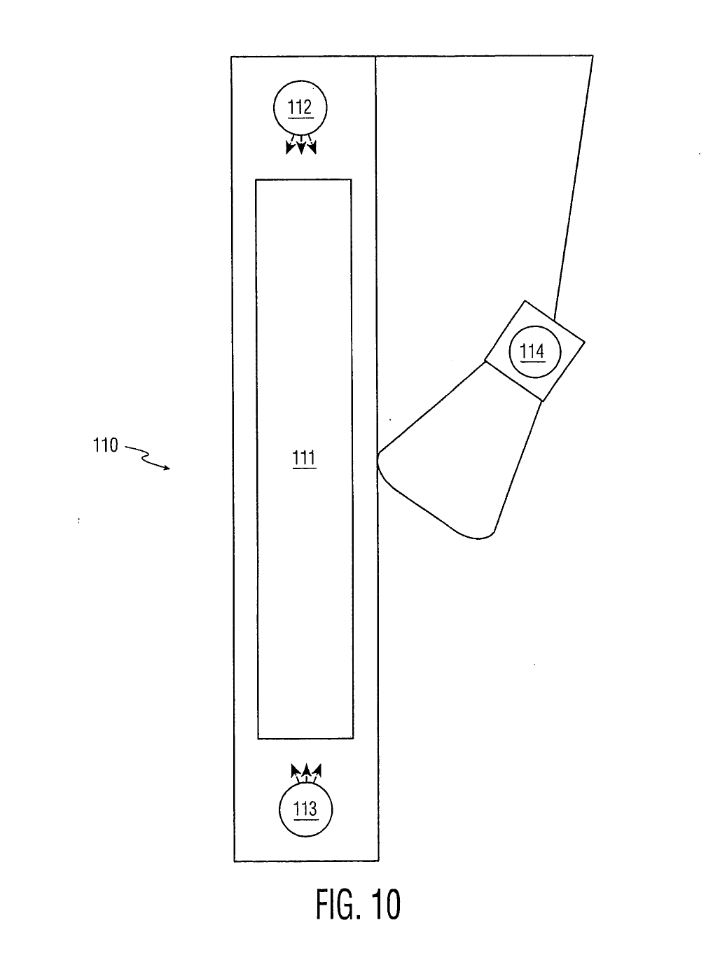

FIG. 10 illustrates an electronic window 110 in the form of a display screen employing a reflective display 111 and two (2) white light sources 112 and 113 facing respective light incident surfaces of reflective display 111. Electronic window 110 further employs one or more colored light sources coupled to a light exiting surface of reflective display 111, such as, for example, a colored light source 114 (e.g., blue) facing the light existing surface of respective display 111 augment the lighting of electronic window 100. The positioning of colored light source 114 relative to the respective light exiting surface of reflective display 111 can be determined to maximize the brightness of electronic window 110.

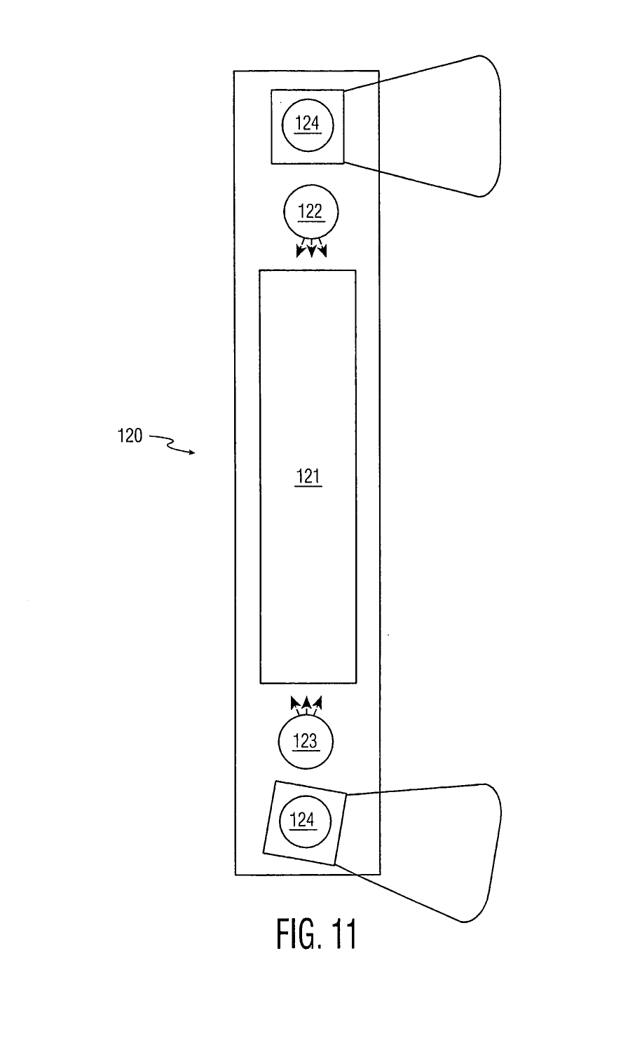

FIG. 11 illustrates an electronic window 120 in the form of a display screen employing a reflective display 121 and two (2) white light sources 122 and 123 facing respective light incident surfaces of reflective display 121. Electronic window 120 further employs one or more colored light sources for a direct emission of local light that is not reflected by reflective display 121, such as, for example, a pair of colored light sources 124 (e.g., red) and 125 (e.g., blue). The positioning of colored light sources 124 and 125 relative reflective display 111 can be determined to maximize the brightness of electronic window 110. In one embodiment, a direction of the light beams of colored light sources 124 and 125 are fixed. Alternatively, a direction of the light beam of colored light source 124 and/or a direction of the light beam of colored light source 125 can be adjusted (e.g., rotated or moved via a shutter system) based on any number of factors, such as, for example, the height of the sun relative to electronic window 120.

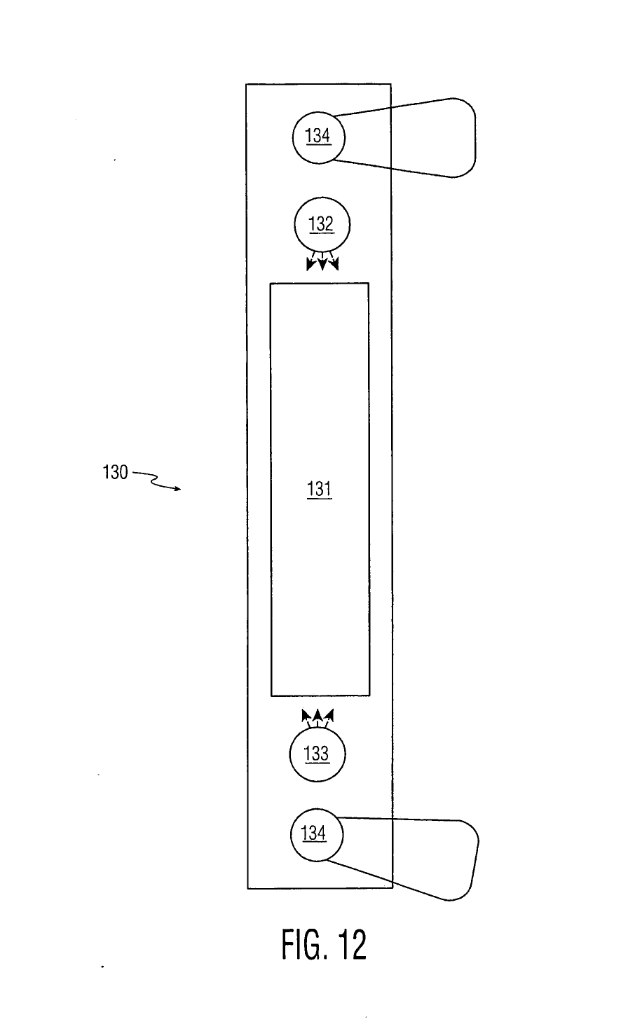

FIG. 12 illustrates an electronic window 130 in the form of a display screen employing a reflective display 131 and two (2) while light sources 132 and 133 facing respective light incident surfaces of reflective display 131. Electronic window 130 further employs one or more collimated light sources for a direct emission of collimated light beams that are not reflected by reflective display 131, such as, for example, a pair of collimated colored light sources 134 (e.g., collimated red TL lamp) and 135 (e.g., collimated blue TL lamp). The positioning of colored light sources 134 and 135 relative reflective display 111 can be determined to maximize the brightness of electronic window 130. In one embodiment, a direction of the light beams of colored light sources 134 and 135 are fixed. Alternatively, a direction of the light beam of colored light source 134 and/or a direction of the light beam of colored light source 135 can be adjusted (e.g., rotated or moved via a shutter system) based on any number of factors, such as, for example, the height of the sun relative to electronic window 130.

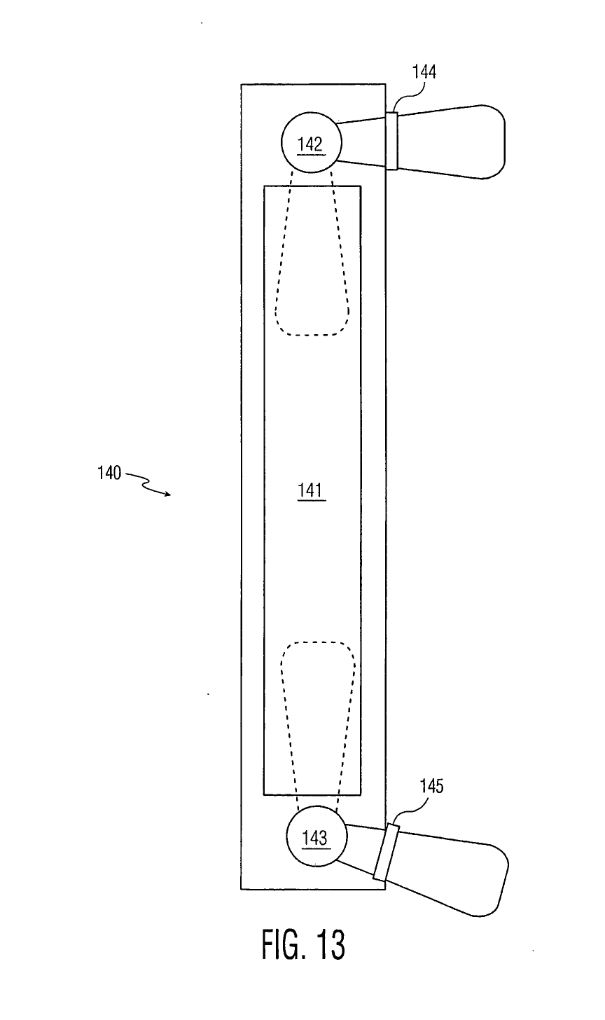

FIG. 13 illustrates an electronic window 140 in the form of a display screen employing a reflective display 141 and two (2) collimated while light sources 142 and 143 facing respective light incident surfaces of reflective display 141. As shown, both light sources 142 and 143 emit one collimated white light beam that is coupled into reflective display 141, and another collimated white light beam that is directed to a colored filters 144 and 145, respectively. The directions of the collimated white light beams from light sources 142 and 143 can be determined to maximize the brightness of electronic window 140. In one embodiment, a direction of the light beams of colored light sources 144 and 145 are fixed. Alternatively, a direction of the light beams of light source 142 and/or a direction of the light beams of light source 143 can be adjusted (e.g., rotated or moved via a shutter system) based on any number of factors, such as, for example, the height of the sun relative to electronic window 140.

From the preceding description of the present invention, those having ordinary skill in the art will appreciate various advantages of the present invention. For example, an electronic window of the present invention can be build in a wall of a dimly lit room (e.g., a hospital room, a hotel room, an indoor shop, a work cubical, etc.) whereby sensation of a glass window is created on a blind wall of the room.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. An electronic window (21), comprising:
an image taking device (22) operable to be mounted outside of a room to thereby provide an image of a scenery external to the room; and
a display screen (21) operable to be mounted within the room and in electrical communication with the image taking device (22) to thereby display the image,
wherein the display screen (21) is further operable to illuminate the image at a luminance level for creating a sensation of a glass window formed in a wall of the room.

2. The electronic window (21) of claim 1, wherein the image taking device (22) is a web camera.

3. The electronic window (21) of claim 1, wherein the luminance level is at least 1000 Cd/m².

4. The electronic window (21) of claim 3, wherein the display screen (21) includes:
a light guide (31); and
at lease one light source (32-35) operable to be optically coupled to the light guide (31).

5. The electronic window (21) of claim 3, wherein the display screen (21) further includes:
an E-ink layer (85);
a first transparent layer (84) overlaying the E-ink layer (85); and
a first light guide (83) overlaying the first transparent layer (84).

6. The electronic window (21) of claim 5, wherein the display screen (21) further includes:
a second transparent layer (82) overlaying the first light guide (83); and
a second light guide (81) overlaying the second transparent layer (82).

7. The electronic window (21) of claim 3, wherein the display screen (21) includes:
an E-ink layer (91);
at lease one light source (92 and 93) operable to be optically coupled to the E-ink layer (91).

8. The electronic window (21) of claim 3, wherein the display screen (109) includes:
a reflective display (101);
at least one white light source (102, 103) operable to be optically coupled to the reflective display (101); and
at least one colored light source (104, 105) operable to be optically coupled to the reflective display (101).

9. The electronic window (21) of claim 3, wherein the display screen (120) includes:
a reflective display (121);
at least one white light source (122, 123) operable to be optically coupled to the reflective display (121); and
at least one colored light source (124, 125) operable to be optically isolated from the reflective display (101).

10. The electronic window (21) of claim 3, wherein the display screen (120) includes:
a reflective display (141);
at least one white light source (142, 143) operable to be optically coupled to the reflective display (141); and
at least one colored filter (144, 145),
wherein each white light source (142, 143) is further operable to be optically coupled to one of the at least one colored filter (144, 145).

11. An electronic window (21), comprising:
at least one lighting source; and
a display operable to optically coupled to the at least one light source, wherein the display is further operable to display and illuminate an image at a luminance level for creating a sensation of a glass window formed in a wall of a room.

12. The electronic window (21) of claim 11, wherein the luminance level is at least 1000 Cd/m²

13. The electronic window (21) of claim 11, wherein the display includes:
a light guide (31) operable to be optically coupled to the at least one light source (32-35).

14. The electronic window (21) of claim 11, wherein the display further includes:
an E-ink layer (85);
a first transparent layer (84) overlaying the E-ink layer (85); and
a first light guide (83) overlaying the first transparent layer (84).

15. The electronic window (21) of claim 14, wherein the display further includes:
a second transparent layer (82) overlaying the first light guide (83); and
a second light guide (81) overlaying the second transparent layer (82).

16. The electronic window (21) of claim 11, wherein the display includes:
an E-ink layer (91) operable to be optically coupled to the at lease one light source (92 and 93).

17. The electronic window (21) of claim 11,
wherein the display includes a reflective display (101); and
wherein the at least one light source includes:
at least one white light source (102, 103) operable to be optically coupled to the reflective display (101); and
at least one colored light source (104, 105) operable to be optically coupled to the reflective display (101).

18. The electronic window (21) of claim 11,
wherein the display includes a reflective display (121);
wherein the at least one light source includes at least one white light source (122, 123) operable to be optically coupled to the reflective display (121); and
further comprising at least one colored light source (124, 125) operable to be optically isolated from the reflective display (101).

19. The electronic window (21) of claim 11,
wherein the display includes a reflective display (141);
wherein the at least one light source includes at least one white light source (142, 143) operable to be optically coupled to the reflective display (141); and
further comprising at least one colored filter (144, 145), wherein colored filter (144, 145) is operable to be optically coupled to one of the at least one white light source (142, 143).

20. A display screen (21), comprising:
means for displaying an image; and
means for illuminating the image at a luminance level for creating a sensation of a glass window on a wall of a room.
